(19) United States
(12) Patent Application Publication
(10) Pub. No.: US 2009/0056972 A1
(43) Pub. Date: Mar. 5, 2009

(54) Shielded electrical cable for data transmission

(75) Inventors: Wolfgang Dlugas, Wipperfurth (DE); Lothar Kundinger, Fuerth (DE)

Correspondence Address: BIRCH STEWART KOLASCH & BIRCH, PO BOX 747, FALLS CHURCH, VA, 22040-0747, US

(73) Assignee: HEW-Kabel/CDT GmbH & Co. KG, Wipperfuerth (DE)

(21) Appl. No.: 12/219,147

(22) Filed: Jul. 16, 2008

(30) Foreign Application Priority Data
Sep. 5, 2007 (DE) 10 2007 041 981.5

(51) Int. Cl. H01B 7/18

(52) U.S. Cl. 174/107

(57) ABSTRACT

A highly flexible shielded electrical line for high-frequency data transmission in swivel-mounted display units having two current supply wires (20; 21) and/or at least two data wires (18; 19), provides a shielding (35) of non-insulated metallic cables enclosing the wires (18; 19; 20; 21), which are stranded and/or bundled or combined in pairs, in their entirety, [the shielding] being covered externally by a conductive non-woven fabric/mesh/mat (36) electrically contacting the shielding (35) all around, the conductive non-woven mat finally being encased by an external sheath (37) made of silicone rubber (FIG. 3).

The present invention relates to a highly flexible shielded electrical line for high-frequency data transmission in swivel-mounted display units, in particular for swivel-mounted LCD (Liquid Crystal Display) devices, having two cables to supply current and/or at least two data cables.

In order to meet the increasing demand for information regardless of the respective location of the interested party, the automotive industry, for example, has long been developing display units integrated in the vehicle, with which the widest variety of data can be made visible, be it information about the condition of the motor vehicle itself, about telephone connections, about radio programs, or about route planning (navigation system). This is particularly true for motor vehicles for the conveyance of passengers. However, it is not always possible to fixedly install the display units needed to display the information in the vehicle, in economy-size vehicles, for example, be it because there is not sufficient space available, be it because the place of installation in the automobile allows only a short-time view. In cases such as these, it is necessary to swivel-mount the display units in the vehicle so that the display units can be folded, swiveled, turned in any desired direction, or retrieved from their present location, for example, from a drawer, in order to put them in a position suitable for the viewer. As a result, the mechanical strain on the electrical cables connected to the display units for data transmission is high. With a rotatable arrangement of the display unit, these cables are pulled, stretched and twisted, whereby a pulling, a stretching and a twisting will not take long to cause damage to the electrical cables, when the ambient temperatures turn very low or very high. It was found, for example, that for permafrost areas, traditional data lines are not suitable to guarantee that the display unit will function. For example, the data lines stiffened in low temperatures make it impossible to either fold out or swivel the display unit, thus, uninterrupted data information is no longer available.

To cure the problem, the twisted and/or bundled electrical conductors of a highly flexible line for high-frequency data transmission have been enclosed by a taping of insulating film coated with aluminum, which is contacted from the inside by a surrounding cable mesh (DE 10 2006 036 621 A1). However, the transmission frequency, that is, the data rate to be transmitted during operation of such a line is, although at a high level, limited, and a further increase of the transmission frequency is not possible.

It is therefore the object of the present invention to provide a data line for the described swivel-mounted display units, which, being highly flexible and largely independent from the prevailing ambient temperatures, guarantees the performance of the display units at optimal quality of the data signals and the reception of data even at high data rates, in ranges of 800 Mbit/sec and more, for example.

According to the invention, this objective is met such that the cables, twisted and/or bundled or gathered in pairs, are encased altogether by a shielding of non-insulated metallic cables, which externally are covered by a conductive non-woven fabric that provides overall electrical contact to the shielding, and that the non-woven fabric cover is finally enclosed by an outer sheath made of silicone rubber. This construction of an electrical data line ensures that the display unit can be moved in any desired direction, even in permafrost conditions, and at the same time data transmission at high data rates of 800 or 1000 MHz without interference. A display unit connected to a line according to the invention can therefore be moved to the front or the back, turned or swiveled in one direction or another, or pulled towards the viewer, or moved away from him, without diminishing the transmission quality of the respective data.

According to the invention, the conductive non-woven fabric can be a plastic mat impregnated with conductive materials, but can also be fleece material interwoven with metallic threads. In a preferred embodiment of the invention, however, the conductive non-woven fabric is a plastic mat coated with metal, wherein the coating is preferably done by vapor deposition onto the plastic mat, for example, vapor deposition of aluminum, or even silver or its alloys.

According to a further embodiment of the invention, all the cables, twisted and/or bundled or gathered in pairs, are held together by an insulating non-woven fabric arranged below the cable mesh. The effect of this insulating non-woven fabric is a further decrease of the friction losses in the line structure, and thus, improved flexibility of the electrical line of the present invention.

Apart from the improved shielding resulting from the conductive non-woven fabric, the increase in transmission frequencies is also due to the insulation of the data cables being double-layered having an inner wrapping of the conductor, the wrapping being a stretched and sintered porous tape, or a film made of a fluorpolymer that is non-melt processable, as well as an outer sealed layer made of a melt-processable fluorpolymer. It is particularly beneficial for the non-melt processable fluorpolymer to be a polytetrafluorethylene, wherein the term polytetrafluorethylene also includes tetrafluorethylene polymers enhanced with modifying additives, of such quantities, however, that the polymer, just like the polytetrafluorethylene, is non-melt processable. This embodiment of the invention has not only the high flexibility with dynamic wiring over a wide temperature range between −50° C. and +180° C., but is also very well suited for a transmission frequency of 800 and 1000 MHz at a shielding attenuation higher than (sic.) 65 dB. A further improvement of this data line is realized, when in a further embodiment of the invention, the PTFE (polytetrafluorethylene) wrapping of the conductor includes a layer of the melt-processable fluorpolymer, which is non-positively connected at least with the uppermost tape or film layer. Since the ratio of the wall thickness of tape or film wrapping to the non-positively connected layer according to the invention is 3:1, this layer is to be considered to be merely a skin layer covering the wrapping. Tetrafluorethylene/hexafluorpropylene copolymer (FEP), perfluoralkoxy polymer (PFA), or tetrafluorethylene perfluoralkylvinylether copolymerisat (TFA/PFA), for example, have been found to be suitable for this skin layer. However, other known melt-processable fluorpolymers can sometimes also find a suitable application.

In a particularly beneficial embodiment of the invention, additional current-supplying cables are arranged, in addition to the single cables provided in the line constructions for the transmission of data. Such a current supply is needed, for example, for the adjusting motor for rotatable display units, or drive motors for the adjustment of mirrors in, or on, motor vehicles. The electrical conductors carrying the supply current of these cables are beneficially insulated by melt-processable fluorpolymer.

It is also beneficial according to the invention for the current supply cables and the data cables to have the same, or almost the same diameter. In this way, it is easy to combine all cables in a uniform strand assembly at the same time. This ensures that under bending stress, all cables exhibit the same bending behavior. If a central filling strand, a so-called snaffle, is needed for rounding the core comprised of stranded cables, then it has been found to be particularly beneficial according to a further embodiment of the invention to fabricate the filling strand of a stretched and sintered molded strand made of polytetrafluorethylene (PTFE). Beneficially, the molded strand is made of a PTFE tape twisted to form a strand. The advantage of a molded strand such as this is its high cold flexibility as well as the absence of material attrition, which, as is the case with glass fiber strands, easily causes the electronic components of rotatable LCD devices to become dirty.

The broad temperature range, in which the data line can be utilized according to the invention, requires suitable material for the sheath. It has been found to be beneficial for the application of the invention to manufacture the outer sheath of a hot-vulcanized silicone rubber, a so-called HTV (high-temperature-vulcanized) silicone rubber. A further beneficial option is to choose an LSR (Liquid Silicone Rubber) for the sheathing material.

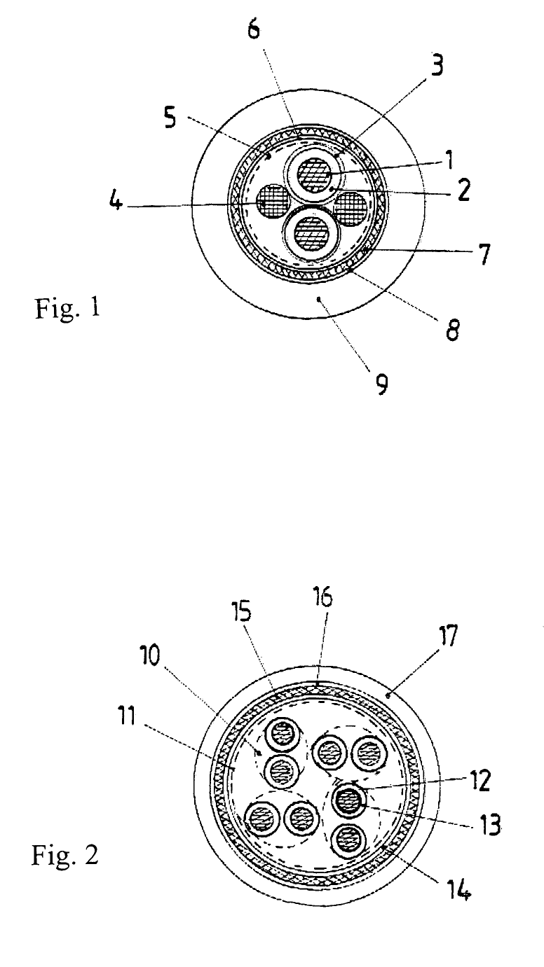

The invention will be described in more detail with reference to the data lines illustrated in FIGS. 1 to 3 as exemplary embodiments. Due to their special characteristics, the electrical lines described herein are particularly well suited for low voltage/high speed data transmission via copper wires (LVDS=Low-Voltage Differential Signaling).

FIG. 1 illustrates a single-pair shielded, highly flexible data line for EMC (electromagnetic compatibility) optimized transmission of data (LVDS interface) having an extremely high reversed bending ability over a broad temperature range, as can be particularly beneficially applied in automotive technology for the connection to rotatable display units. The copper conductors 1 having a diameter of 0.50 mm, for example, are hereby insulated with a wrapping 2 of a stretched and sintered tape, or a suitable film of polytetrafluorethylene (PTFE), which is, or are, known under the trade name HEI-tape® of the applicant. The wrapping 2 of PTFE tape has a skin layer 3 of a melt-processable fluorpolymer, for example, of a tetrafluorethylene/hexafluorpropylene copolymer (FEP). Filling strands 4 in the wedges of the stranded individual cables serve to stabilize the strand assembly; they can be fabricated of a suitable synthetic material but can also be made of glass fibers. The strand assembly 5 comprised of the aforementioned individual elements is enclosed by the taping 6 made of an insulating non-woven fabric. A shielding mesh of tin-coated copper wires has the reference numeral 7; is it covered by the taping 8 made of a non-woven fabric coated by vapor deposition with aluminum or silver, either on one side only or on both sides. The outer sheathing of the data line of the present invention is the sheath 9 of a hot-temperature vulcanized (HTV) silicone rubber. The outer diameter of this data line constructed according to the invention is approximately 4.5 mm; the operational voltage for application in the automotive technology is 48 Volt.

To accommodate the demands put on such data lines, an embodiment of the invention according to FIG. 2 can be deployed. In this data line, four pairs 10 are combined in one strand assembly 11. In this embodiment, the electrical conductors 12 of the pairs 10 having an outer diameter of 0.6 mm, for example, are made of blank, tin-coated or silver-coated copper wires. The insulation 13 of the conductors 12 is made of one of the aforementioned melt-processable fluorpolymers, an FEP, for example. The taping 14 enclosing all four pairs together can be a film wrapping of a polyester tape; however, according to an exemplary embodiment according to FIG. 1, an insulating, friction-reducing non-woven fabric can also assume the function of the taping. The mesh 15 comprised of tin-coated or silver-coated copper wires serves the purpose of shielding the data line, which in turn is enclosed by the taping 16 made of a metallized non-woven fabric to improve the shielding effect, and thus optimizing the data transmission. The data line of the present invention is sealed on the outside by the sheath 17 made of an HTV silicone rubber or an LSR rubber, for example.

The silicone rubber sheath, which remains consistently flexible even in low temperatures, again ensures, together with the described structural elements of the data line, reverse bending ability, which allows dynamic wiring with swivel-mounted display units or those retrievable from drawers or covers. The outer diameter of electrical lines of this embodiment is approximately 6.0 to 6.50 mm, operational voltage is also 48 Volt.

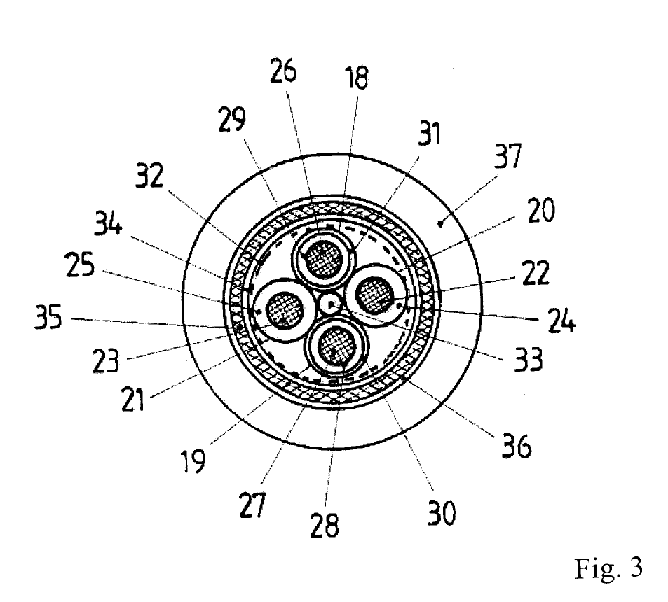

Similar to FIG. 1, FIG. 3 illustrates a particularly beneficial embodiment of the invention, wherein the single cables 18 and 19 designated for data transmission, and the two cables 20 and 21 supplying current to adjusting motors for swivel-mounted display units, for example, the diameters of which are at least nearly equal to said single cables, are stranded together. Since cables 20 and 21 are not utilized for data transmission, their electrical conductors 22 and 23 are merely provided with insulation, 24 and 25 respectively, made of a melt-processable fluorpolymer, an FEP, for example.

Conversely, an insulation having a low dielectric constant is of great importance for the data transmission, in a size range of 1.3, for example. For this reason, the conductors 26 and 27 of the single cables 18 and 19 are first insulated with a wrapping, 28 and 29 respectively, of a stretched and sintered tape or a suitable film of polytetrafluorethylene. These tape or film wrappings are covered by insulating layers, 30 and 31 respectively, made of a meltable fluorpolymer, in the illustrated exemplary embodiment of the aforementioned FEP.

In the center of the strand assembly 32 formed of cables 18, 19, 20 and 21, the filling strand (snaffle) 33 is arranged. To increase the flexibility of this line even in extremely low temperatures, for example; as low as −50° C., said filling strand is a stretched and sintered, that is, porous PTFE tape twisted into a strand. Apart from the high cold flexibility of the filling strand of the present invention, using this material has the advantage that soiling due to material attrition as a result of the motions of the attached swivel-mounted devices executed when the line is in operation are avoided.

The strand assembly 32 comprising said cables is enclosed by the taping 34 made of an insulating non-woven fabric, inside which the strand assembly 32 is subjected to extremely minimal friction. If, as illustrated, the insulating non-woven fabric is covered by the shielding mesh 35, made of tin-coated copper wires, for example, the shielding mesh 35 is easily moved across the strand assembly 32 in the direction of the axle for installation purposes; the insulating non-woven fabric, however, also helps to increase the flexibility of the entire line. To improve the shielding effect and to optimize the data transfer, the taping 36 comprised of a non-woven fabric coated, preferably by vapor deposition, with metal either on one side or on both sides, is arranged over the shielding mesh 35. The metal is preferably aluminum, silver, or other conductive materials suitable for the coating process. The outer sheathing of the line of the present invention is formed by a sheath 37 of silicone rubber. The outer diameter of this data line according to the invention is approximately 4.8 mm, the operational voltage, due to its application in the automotive technology, is 48 Volt. The particular benefit of this cable assembly according to the invention is the unproblematic deployment in a temperature range from about −50° C. to +135° C. and above, at consistently high flexibility as well as interference-free data transmission at a data rate of more than 800 or 1000 Mbit/sec.

1. Highly flexible shielded electrical line for high-frequency data transmission in swivel-mounted display units, in particular swivel-mounted LCD devices, having two current supply wires and/or at least two data wires, characterized in that the wires, twisted and/or bundled or gathered in pairs, are all held together by a shielding of non-insulated metallic wires, which externally are covered by a conductive non-woven fabric electrically contacting the entire shielding, and that finally, this conductive non-woven fabric shielding is enclosed by an outer shield made of a silicone rubber.

2. Electrical line according to claim 1, characterized in that the conductive non-woven fabric is a plastic mat impregnated with conductive materials.

3. Electrical line according to claim 1, characterized in that the conductive non-woven fabric is a plastic mat interwoven with metallic threads.

4. Electrical line according to claim 1, characterized in that the conductive non-woven fabric is a plastic mat coated with metal.

5. Electrical line according to claim 4, characterized in that the conductive non-woven fabric is a plastic mat metal-coated on one or both sides by vapor deposition.

6. Electrical line according to claim 3 or one of the subsequent claims, characterized in that the metal is aluminum or an aluminum alloy.

7. Electrical line according to claim 3 or one of the subsequent claims, characterized in that the metal is silver or a silver alloy.

8. Electrical line according to claim 3 or one of the subsequent claims, characterized in that the external conductive non-woven fabric cover of the shielding is a wound tape of the conductive non-woven fabric.

9. Electrical line according to claim 1 or one of the subsequent claims, characterized in that the wires, which are twisted and/or bundled or gathered in pairs, are all held together by an insulating non-woven fabric arranged below the wire mesh.

10. Electrical line according to claim 1 or one of the subsequent claims, characterized in that the insulation of the data wires is two-layered, with the inner wrapping of the conductor being a stretched and sintered porous tape or a film of non-melt-processable fluorpolymer, and an outer sealed layer of a melt processable fluorpolymer.

11. Electrical line according to claim 10, characterized in that the non-melt-processable fluorpolymer is a polytetrafluorethylene.

12. Electrical line according to claim 10, characterized in that the outer sealed layer is non-positively connected to at least the uppermost tape or film layer of the inner wrapping.

13. Electrical line according to claim 1 or one of the subsequent lowing claims, characterized in that the insulation of the current supply wires is made of a melt-processable fluorpolymer.

14. Electrical line according to claim 1 or one of the subsequent claims having a central filling strand, around which the single wires or pairs of wires are twisted, characterized in that the filling strand is a stretched and sintered molded strand made of polytetrafluorethylene.

15. Electrical line according to claim 14, characterized in that the stretched and sintered filling strand is a tape made of polytetrafluorethylene twisted into a strand.

16. Electrical line according to claim 10 or one of the subsequent claims, characterized in that the ratio of the wall thickness of the tape or film wrapping to the non-positively connected sealed layer is approximately 3:1.

17. Electrical line according to claim 1 or one of the subsequent claims, characterized in that the diameter of the current supply wires and the diameter of the data wires is identical, or almost identical.

18. Electrical wire according to claim 1 or one of the subsequent claims, characterized in that the current supply cables and the data cables are at the same time twisted together.

19. Electrical line according to claim 1 or one of the subsequent claims, characterized in that the outer shield of the line is a hot-temperature vulcanized (HTV) silicone rubber.

20. Electrical line according to claim 1 or one of the subsequent claims, characterized in that the outer shield of the line is an LSR (Liquid Silicon Rubber) rubber.

21. Electrical line according to claim 1 or one of the subsequent claims, characterized in that in the dynamic state, the shielded electrical line has a high flexibility at temperatures from −50° C. to +180° C. at a data rate to be transmitted of >800 Mbit/sec.

22. Application of the electrical line according to claim 1 or one of the subsequent claims for low voltage/highspeed data transmission via copper wires (Low Voltage Differential Signaling).
